(19) United States
(12) Patent Application Publication
(10) Pub. No.: US 2022/0174241 A1
(43) Pub. Date: Jun. 2, 2022

(54) VEHICLE COMPRISING A VIEWING SYSTEM AND METHOD FOR ADJUSTING POSITION OF A MONITOR OF THE VIEWING SYSTEM

(71) Applicant: Volvo Truck Corporation, Göteborg (SE)

(72) Inventors: Nicolas BERNE, Heyrieux (FR); Sébastien DURAN, High Point, NC (US)

(21) Appl. No.: 17/441,385

(22) PCT Filed: Mar. 26, 2019
(86) PCT No.: PCT/EP2019/057523

§ 371 Date: Sep. 21, 2021

(51) Int. Cl. H04N 7/18; B60R 1/22; B60R 11/02; H04N 5/225

(52) U.S. Cl. CPC H04N 7/183; B60R 1/22; B60R 2011/0022; H04N 5/225251; B60R 11/0235

(57) ABSTRACT

A vehicle comprising a viewing system including at least one camera, a monitor and a support, the support comprising a movable support part supporting the monitor and movably mounted on a fixed support part secured to a frame of the vehicle, a biasing system comprising a locking device mounted on the fixed support part and configured to impart a load to the movable support part so as to maintain the movable support part in a position with respect to the fixed support part, and a pneumatic releasing device configured to inject compressed air in the locking device to release the movable support part from the load.

### FIELD OF THE DISCLOSURE

The invention relates to a vehicle comprising a viewing system and to a method for adjusting position of a monitor of the viewing system.

### BACKGROUND OF THE DISCLOSURE

A viewing system is used in a vehicle to provide a driver installed at a driving place of a compartment of the vehicle with one or several views of surroundings of the vehicle.

Viewing systems have long implemented mirrors to provide the views.

Mirrors in viewing systems are progressively replaced by cameras connected to a monitor so that the same views can be provided in a more accurate manner and with a better modularity thanks to the ability of processing images of the views upon acquisition by the cameras and/or display by the monitor.

The monitor is arranged within the compartment of the vehicle through a support part comprising a fixed support part secured to a frame of the vehicle, and a movable support part supporting the monitor. The movable support part is movably mounted on the fixed support part to present a plurality of positions with respect to the fixed support part. The position of the monitor can be adjusted to ease accessibility to the driving place and to improve visibility of the image displayed on the monitor depending on lightening conditions and reflections.

However, the monitor is subjected to vibrations which not only affect the visibility of the image but also reduces lifetime of the monitor or at least of the support.

### SUMMARY OF THE DISCLOSURE

The invention aims at solving the above mentioned problems.

To this end, according to a first aspect, the invention proposes a vehicle comprising:
a frame defining a compartment with a driving place, and
a viewing system configured to provide a driver installed at the driving place with at least one view of surroundings of the vehicle,

wherein the viewing system includes:
at least one camera configured to acquire the view of the surroundings,
at least one monitor connected to the camera and configured to display the view of the surroundings,
at least one support comprising a fixed support part secured to the frame within the compartment, and a movable support part supporting the monitor, the movable support part being movably mounted on the fixed support part to present a plurality of positions with respect to the fixed support part,

wherein the vehicle comprises a biasing system presenting a locked state in which the movable support part is maintained in one of the positions with respect to the fixed support part, and an unlocked state in which the movable support part is movable with respect to the fixed support part, and

wherein the biasing system comprises a locking device mounted on the fixed support part and configured to impart a load to the movable support part in the locked state of the biasing system, and a pneumatic releasing device configured to inject compressed air at a releasing pressure in the locking device so as to release the movable support part from the load in the unlocked state of the biasing system.

Hence, through the imparted load, the locking device presents a suitable rigidity that enables vibrations to be absorbed. Premature deterioration of the support and the monitor can be avoided and visibility of the image displayed on the monitor is no longer affected by vibrations. Load on the movable support part can be released only in clearly identified situations, possibly decided by the driver, to adjust the position of the monitor.

The locking device may include:
a cylinder having a housing extending along a cylinder axis, the cylinder having an injection portion provided with an inlet opening in the housing, and an abutment surface extending transversely with respect to the cylinder axis at a distance from the inlet along the cylinder axis,
a locking member having

a base mounted in the housing of the cylinder between the inlet and the abutment surface so as to reciprocate along the cylinder axis, the base defining with the injection portion of the cylinder an injection chamber, and

a contact element extending from the base) and protruding from the cylinder opposite the injection chamber,
an urging arrangement,

wherein, in the locked state of the biasing system, the urging arrangement is configured to impart the load between the base of the locking member and the abutment surface of the cylinder, the locking member being in a blocking position in which the base is spaced apart from the abutment surface and the contact element is urged against the movable support part, and

wherein, in the unlocked state of the biasing system, the pneumatic releasing device is configured to inject compressed air in the injection chamber through the inlet against the load of the urging arrangement, the locking member being in a releasing position in which the base is close to the abutment surface and the contact element of the locking member being spaced apart from the movable support part.

The urging arrangement may be a resilient member placed between the base of the locking member and the abutment surface of the cylinder, the resilient member being in an extended state in the locked state of the biasing system, and in a retracted state in the unlocked state of the biasing system.

Alternatively, the urging arrangement may be a pneumatic urging device configured to inject compressed air at a loading pressure between the base of the locking member and the abutment surface of the cylinder in the locked state of the biasing system.

The contact element may comprise a rod extending from the base along an extension axis parallel to the cylinder axis towards a free end, the free end being in contact with the movable support part in the blocking position of the locking member, and spaced apart from the movable support part in the releasing position of the locking member.

Alternatively, the contact element may comprise a rod extending from the base along an extension axis parallel to the cylinder axis, and a lever rotatably mounted on the rod about a pivot axis perpendicular to the extension axis, the lever having a contact surface at a distance from the pivot axis, the lever presenting a first inclination in the blocking position of the locking member, in which the contact surface is in contact with the movable support part, and a second inclination in the releasing position of the locking member, in which the contact surface is spaced apart from the movable support part.

The movable support part may be movable along a displacement direction and present a transverse surface perpendicular to the displacement direction, the transverse surface moving along a stroke as the movable support part is moved along the displacement direction, and

the contact element may comprise a stop surface arranged to be in contact with the transverse surface of the movable support part in the blocking position of the locking member, and spaced apart from the stroke of the transverse surface of the movable support part in the releasing position of the locking member.

The pneumatic releasing device may comprise a source of compressed air, a pipe connecting the source of compressed air to the locking device and an actuator for controlling supply of compressed air by the source of compressed air, the actuator being arranged within the compartment so as to so as to be actuated by the driver.

The vehicle may further comprise a steering wheel at the driving place and a height adjusting system for adjusting height of the steering wheel, the source of compressed air and the actuator of the pneumatic releasing device being part of the height adjusting system.

The movable support part may be movable in rotation along at least one rotation axis with respect to the fixed support part.

Alternatively, the fixed and movable support parts have respective spherical contact surfaces configured to slide against each other in the unlocked state of the biasing system.

According to a second aspect, the invention proposes a method for adjusting position of a monitor of a viewing system configured to provide a driver installed at a driving place of a compartment of a vehicle with at least one view of surroundings of the vehicle, the viewing system comprising at least one camera configured to acquire the view of the surroundings, the monitor being connected to the camera and configured to display the view of the surroundings, the monitor being supported by a movable support part of a support, the movable support part being movably mounted on a fixed support part of the support to present a plurality of positions with respect to the fixed support part, the fixed support part being secured to a frame of the vehicle defining the compartment, and

the movable support part being maintained in one of the positions with respect to the fixed support part in a locked state of a biasing system, a locking device of the biasing system being mounted on the fixed support part and imparting a load to the movable support part,

the method comprising placing the biasing system in an unlocked state in which the movable support part is movable with respect to the fixed support part, a pneumatic releasing device of the biasing system injecting compressed air in the locking device so as to release the movable support part from the load.

When the locking device comprises a cylinder, a locking member and an urging arrangement as defined previously, in the locked state of the biasing system, the urging arrangement imparting the load between the base of the locking member and the abutment surface of the cylinder, the locking member being in a blocking position in which the base is spaced apart from the abutment surface and the contact element is urged against the movable support part, and

in the unlocked state of the biasing system, the pneumatic releasing device injects compressed air in the injection chamber through the inlet against the load of the urging arrangement, the locking member being in a releasing position in which the base is close to the abutment surface and the contact element is spaced apart from the movable support part.

### BRIEF DESCRIPTION OF THE DRAWINGS

Other objects and advantages of the invention will emerge from the following disclosure of particular embodiments of the invention given as non limitative examples, the disclosure being made in reference to the enclosed drawings in which:

FIG. 1 is a representation of a vehicle comprising a frame defining a compartment with a driving place, and a viewing system comprising a camera mounted on a lateral wing to acquire a side view of surroundings of the vehicle,

FIG. 2 is a representation of a field of view of a driver installed at the driving place of the vehicle of FIG. 1, the viewing system further comprising a monitor arranged within the compartment and connected to the camera to display the side view of the surroundings,

FIG. 3 is a representation of a support of the viewing system of the vehicle of FIG. 1 according to a first embodiment of the invention, the support comprising a fixed support part secured to the frame within the compartment, and a movable support part supporting the monitor, the movable support part being mounted in rotation along a rotation axis on the fixed support part to present a plurality of positions with respect to the fixed support part,

FIG. 4 is a representation of a biasing system of the vehicle of FIG. 1 in a locked state in which the movable support part of the support of FIG. 3 is maintained in one of the positions with respect to the fixed support part, the biasing system comprising a locking device mounted on the fixed support part, the locking member comprising a cylinder, a locking member and an urging arrangement, the locking member comprising a base reciprocating in the cylinder and a contact element, the urging arrangement imparting a load to the moveable support part through the contact element, the urging arrangement being a resilient member in an extended state, the contact element comprising a rod extending from the base towards a free end in contact with the movable support part,

FIG. 5 is a representation of the biasing system in an unlocked state in which the movable support part of the support of FIG. 3 is movable with respect to the fixed support part, the biasing system comprising a pneumatic releasing device injecting compressed air in the locking device against the load of the resilient member, the resilient member being in a retracted state, the free end of the rod of the contact element being spaced apart from the movable support part,

FIG. 6 is a representation of a support of the viewing system of the vehicle according to a first variant of the first embodiment of FIG. 3, the movable support part presenting a transverse surface moving along a stroke as the movable support part is moved along a displacement direction, and the contact element comprising a stop surface arranged to be in contact with the transverse surface of the movable support part in the locked state of the biasing system, and spaced apart from the stroke of the transverse surface of the movable support part in the unlocked state of the biasing system,

FIG. 7 is a representation of a support of the viewing system of the vehicle according to a second variant of the first embodiment of FIG. 3, the fixed and movable support parts having overlapping walls against which the load is imparted in the locked state of the biasing system,

FIG. 8 is a representation of a support of the viewing system of the vehicle according to a third variant of the first embodiment of FIG. 3, the biasing system being in the locked state, the contact element comprising a rod and a lever rotatably mounted on the rod about a pivot axis, the lever having a contact surface at a distance from the pivot axis and presenting a first inclination in which the contact surface is in contact with the movable support part,

FIG. 9 is a representation of the support of the viewing system of the vehicle according to the third variant of FIG. 8, the biasing system being in the unlocked state, the lever presenting a second inclination in which the contact surface is spaced apart from the movable support part,

FIG. 10 is a representation of a support of the viewing system of the vehicle according to a fourth variant of the first embodiment of FIG. 3, the urging arrangement being a pneumatic urging device configured to impart the load through air injection,

FIG. 11 is a representation of a support of the viewing system of the vehicle of FIG. 1 according to a second embodiment of the invention, the fixed and movable support parts having respective spherical contact surfaces configured to slide against each other in the unlocked state of the biasing system,

FIG. 12 is a representation of the biasing system in the locked state in which the movable support part of the support of FIG. 11 is maintained in one of the positions with respect to the fixed support part,

FIG. 13 is a representation of the biasing system in the unlocked state in which the movable support part of the support of FIG. 11 is movable with respect to the fixed support part.

### DETAILED DESCRIPTION

In the figures, the same reference numbers refer to the same or similar elements.

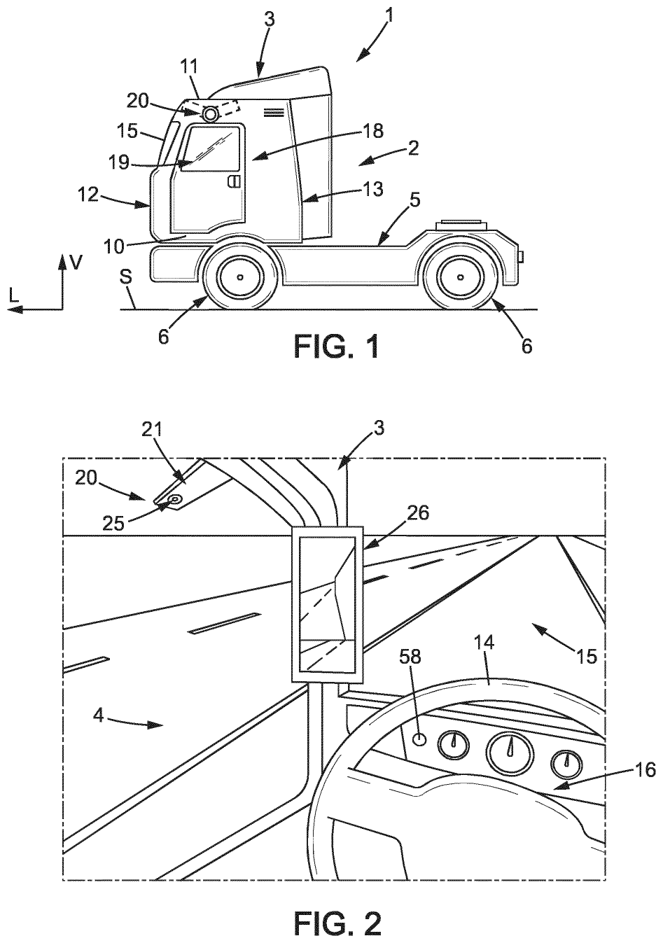

FIG. 1 represents a vehicle 1 according to an embodiment of the invention. In the represented embodiment, although not limited thereto, the vehicle 1 is a tractor of a truck comprising a frame 2 extending along a longitudinal direction L corresponding to a direction along which the vehicle 1 moves forward or rearward on a ground surface S. The frame 2 comprises a driver cab 3 defining a compartment 4 with a driving place where a driver may seat, and a chassis 5 adjoining the driver cab 3 in the longitudinal direction L.

The driver cab 3 and the chassis 5 are mounted on wheels 6 driven by a motor system.

The driver cab 3 comprises:
a floor 10 and a roof 11 delimiting the compartment 4 in a vertical direction V perpendicular to the ground surface S and to the longitudinal direction L,
opposite front 12 and back 13 walls delimiting the compartment 4 in the longitudinal direction L, the front wall 12 being provided with a windshield 15 on an upper part, close to the roof 11, and with a front control panel 16 on a lower part, close to the floor 11, behind a steering wheel 14.
side walls 18 delimiting the compartment 4 in a transverse direction T perpendicular to the longitudinal L and vertical V directions, the side walls 18 being provided with respective driver and passenger doors 19.

As shown in FIGS. 1 and 2, the vehicle 1 comprises a viewing system 20 configured to provide a driver installed at the driving place with one or several view of surroundings of the vehicle 1.

In FIGS. 1 and 2, the viewing system 20 is especially configured to provide a side view of the surroundings arranged rearward and at a side of the driving place.

The viewing system 20 comprises a camera 25 configured to acquire the side view of the surroundings. The camera 25 is mounted on a lateral wing 21 arranged outward the compartment 4, on a side of the frame 2 of the vehicle 1, namely at a distance in the transverse direction T from the driving place, between the roof 11 and the driver door 19.

The viewing system 20 also comprises a monitor 26 connected to the camera 25 and configured to display the side view of the surroundings. The monitor 26 is mounted on a support 30 arranged within the compartment 4.

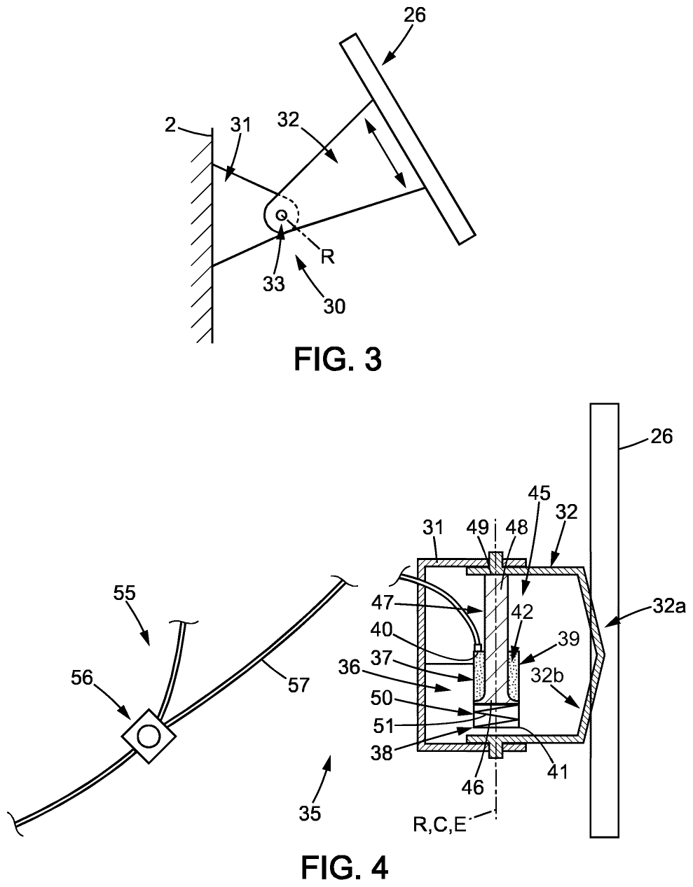

In FIG. 3, the support 30 comprises a fixed support part 31 secured to the frame 2 of the vehicle, within the compartment 4, and a movable support part 32 supporting the monitor 26. The movable support part 32 presents a back surface 32b directed towards the fixed support part 31 and a front surface 32a opposite the back surface 32b. The movable support part 32 is movably mounted on the fixed support part 31 to present a plurality of positions with respect to the fixed support part 31.

In particular, in the first embodiment, a pivot 33 extending along the transverse direction T connects the movable support part 32 to the fixed support part 31. The movable support part 32 is then movable in rotation about a rotation axis R parallel to the transverse direction T with respect to the fixed support part 31. The movable support part 32 is movable along a rotational displacement direction around the rotation axis R so that a vertical inclination of the monitor 26 can be adjusted.

The vehicle 1 comprises a biasing system 35 presenting a locked state in which the movable support part 32 is maintained in one of the positions with respect to the fixed support part 31, and an unlocked state in which the movable support part 32 is movable with respect to the fixed support part 31.

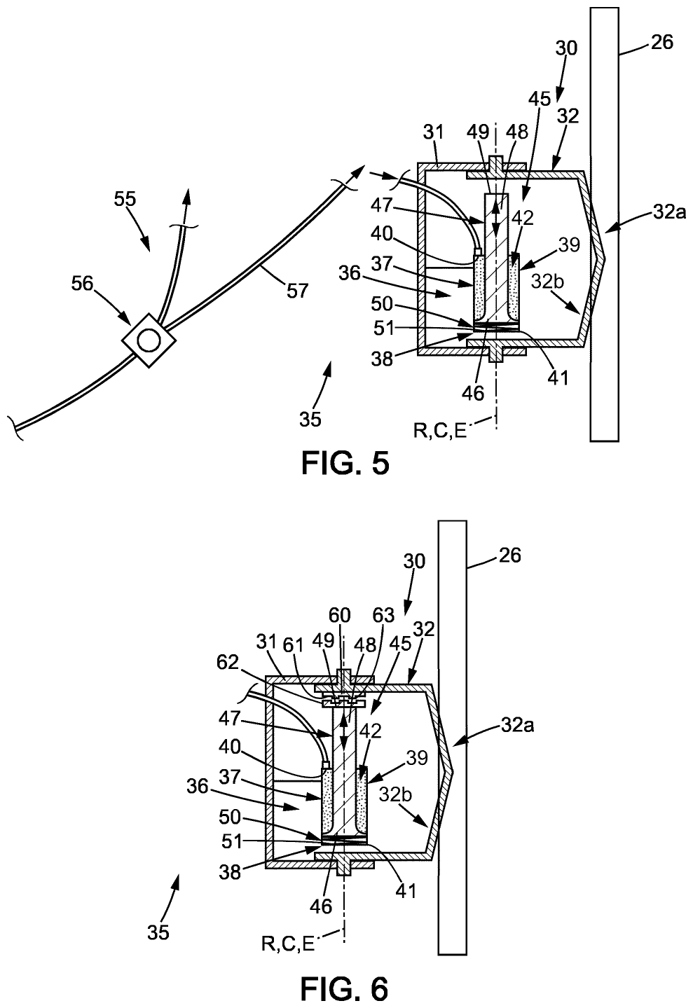

In FIGS. 4 and 5, the biasing system 35 comprises a locking device 36 mounted on the fixed support part 31.

The locking device 36 includes a cylinder 37 having a housing 38 extending along a cylinder axis C that is parallel to the rotation axis in the represented embodiment. The cylinder 37 has an injection portion 39 provided with an inlet 40 opening in the housing 38. The cylinder 37 also has an abutment surface 41 which extends transversely with respect to the cylinder axis C at a distance from the inlet 40 along the cylinder axis C. In the represented embodiment, the inlet 40 and the abutment surface 41 are arranged at opposite transverse first and second end walls of the cylinder 37.

The locking device 36 includes a locking member 45 having a base 46 mounted in the housing 38 of the cylinder 37 between the inlet 40 and the abutment surface 41 so as to reciprocate along the cylinder axis C. In particular, the base 46 has an outer edge in tight contact with a lateral wall of the cylinder 37 extending between the first and second end walls of the cylinder 37. The base 46 defines with the injection portion 39 of the cylinder 37 a hermetically closed injection chamber 42. The locking member 45 also has a contact element 47 extending from the base 46 and protruding from the cylinder 37 opposite the injection chamber 42. The contact member 47 has a rod 48 extending along an extension axis E parallel to the cylinder axis, towards a free end 49. In the embodiment represented in FIGS. 4 and 5, the locking member 45 is configured so that the free end 49 of the contact member 47 protrudes through the first end wall of the cylinder 37, on a side of the inlet 40.

The locking device 36 also includes urging arrangement 50 in the form of a resilient member 51, in particular a compression spring, extending between the base 46 of the locking member 45 and the abutment surface 41 of the cylinder 37.

In FIG. 4, the resilient member 51 is in an extended state to place the locking member 45 in a blocking position in which the base is spaced apart from the abutment surface 41, the rod 48 protrudes from the housing 38 of the cylinder 37 and the free end 49 of the contact element 47 is urged in contact against the back surface 32b of the movable support part 32. The resilient member 51 then applies a load to the movable support part 32 of the support 32 so as to maintain the movable support part 32 in one of the positions with respect to the fixed support part 31. Such configuration defines a locked state of the biasing system 35.

The biasing system 35 comprises a pneumatic releasing device 55 configured to place the biasing system 35 in an unlocked state in which the movable support part 32 is movable with respect to the fixed support part 31.

The pneumatic releasing device 55 comprises a source of compressed air 56, a pipe 57 connecting the source of compressed air 56 to the locking device 36 and an actuator 58 for controlling supply of compressed air by the source of compressed air 56. More specifically, the pipe 57 is connected to the inlet 40 of the cylinder 37 of the locking device 36. The actuator 58 is arranged in any suitable position within the compartment 4, for example on the front panel 16, so as to be actuated by the driver in any desired situation. In an advantageous example, the vehicle 1 may further comprises a height adjusting system for adjusting height of the steering wheel 14. The source of compressed air 56 and the actuator 58 of the pneumatic releasing device 55 may be part of the height adjusting system so that the adjustment of the position of the display can take place at the same time as the adjustment of the height of the steering wheel 14.

In FIG. 5, upon actuation of the actuator 58 by the driver, compressed air from the source of compressed air 56 may be injected in the injection chamber 42 through the pipe 57 and the inlet 40 to move the resilient member 51 to a retracted state thereby moving the locking member 45 towards a releasing position in which the base 46 is close to the abutment surface 41 of the cylinder 37, i.e. the locking member 45 is brought closer to the abutment surface 41 than in the blocking position, the rod 48 is retracted within the housing 38 of the cylinder 37 and the free end 49 of the contact element 47 is spaced apart from the back surface 32b of the movable support part 32. The compressed air is injected at a releasing pressure sufficient to overcome the load of the resilient member 51. The movable support part 32 is then released from the load of the resilient member 51 and can be moved in any suitable position with respect to the fixed support part 31. Such configuration defines an unlocked state of the biasing system 35.

It is noted that, in the locked state of the biasing system 35, either no compressed air at all is injected in the injection chamber 42 of the locking device 36 or compressed air at a pressure lower than the releasing pressure and than the load applied by the resilient member 51 is injected.

The invention has been disclosed in relation with a locking device able to maintain the movable support part 32 in position by friction of the free end 49 of the contact element 47 to which a sufficient load is applied.

In a first variant, shown in FIG. 6, an engagement of the contact element 47 with the movable support part 32 can be provided in addition to or replacement of the friction.

To that end, the movable support part 32 presents a first toothing 60 provided with one or several transverse surfaces 61 perpendicular to the rotational displacement direction. Each transverse surface 61 moves along a rotational stroke as the movable support part 32 is moved along the displacement direction. The free end 49 of the contact element 47 is provided with a second toothing 62 complementary to the first toothing 60 of the movable support part 32 and presenting at least one stop surface 63 arranged to be in contact with the transverse surface 61 of the first toothing 60 of the movable support part 32 in the blocking position of the locking member 45, and spaced apart from the stroke of the transverse surface 61 of the movable support part 32 in the releasing position of the locking member 45.

These provisions are not limited to a rotational displacement direction of the movable support part 32 and apply to any displacement direction. They ensure maintenance of the movable support part 32 in position even if an external force is, intentionally or not, applied to the monitor 26. In the case of a rotational displacement direction of the movable support part 32, they further provide an indexation of the relative position of the movable support part 32 and the fixed support part 31.

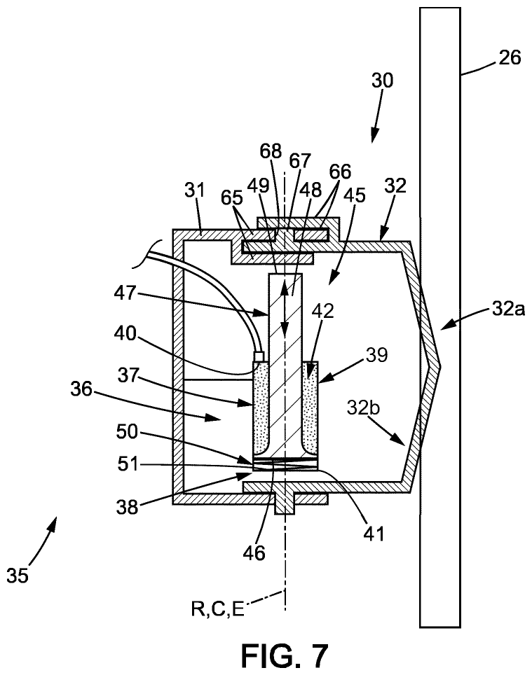

As a matter of position indexation and avoidance of undesired change of position, in a second variant shown in FIG. 7, the fixed 31 and movable 32 support parts have respective overlapping walls 65, 66 against which the load is imparted in the locked state of the biasing system 35. These overlapping walls 65, 66 enhance the friction between the fixed 31 and movable 32 support parts as the load is applied. In addition, one of the overlapping walls 65, 66 may be provided with a plug 67 arranged within a groove 68 formed ion the other of the overlapping walls 65, 66 to limit an angular sector in which the movable support part 32 is movable with respect to the fixed support part 31.

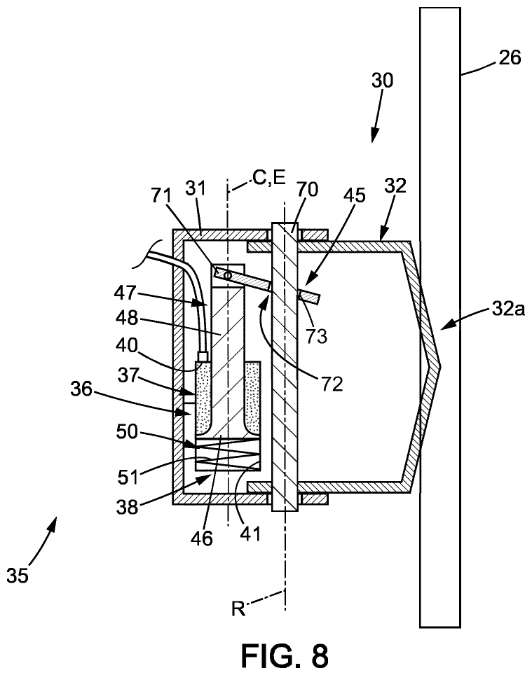

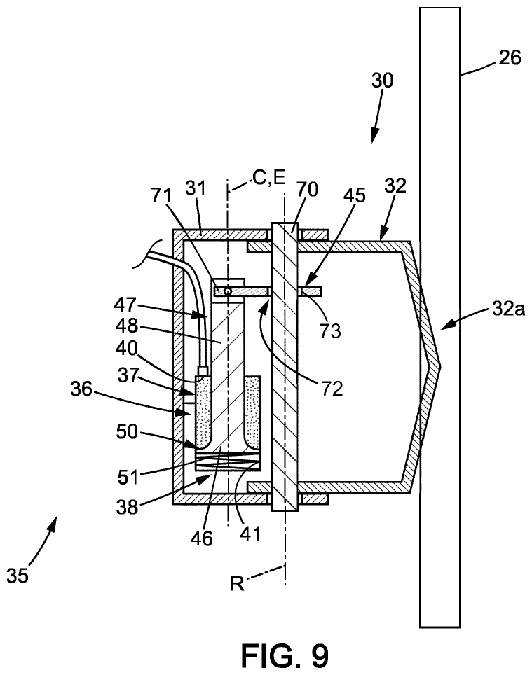

The invention has been disclosed in relation with a biasing system 35 of which locking device 36 extends along the rotation axis R. The invention is however not limited to such embodiment. In particular, FIGS. 8 and 9 show a third variant of the first embodiment in which the locking device 36 is offset from the rotation axis R and the contact element 47 is conformed in a corresponding manner.

In the third variant, a pivot shaft 70 secured to the movable support part 32 extends along the rotation axis R.

The contact element 47 further comprises a lever 71 rotatably mounted on the free end 49 of the rod 48 about a pivot axis perpendicular to the extension axis E. In particular, the lever 71 has an opening 72 at a distance from the pivot axis and in which the pivot shaft 70 extends. The opening 72 is delimited by a contact surface 73.

In FIG. 8, the biasing system 35 is in the locked state, the resilient member 51 pushing the locking member 45 in the blocking position so that the lever 71 presents a first inclination in which the contact surface 73 is in contact with the pivot shaft 70 of the movable support part 32 thereby impeding any rotation of the movable support part 32 with respect to the fixed support part 31.

In FIG. 9, the biasing system 35 is in the unlocked state, the compressed air injected at the releasing pressure by the pneumatic releasing device 55 moves the locking member 45 back to the releasing position so that the lever 71 presents a second inclination in which the contact surface 73 is spaced apart from the pivot shaft 70 of the movable support part 32 thereby allowing the movable support part 32 to freely rotate with respect to the fixed support part 31.

The invention has been disclosed in relation with an urging arrangement 50 formed by a resilient member 51. The urging arrangement 50 may however be of any suitable kind to impart the load between the base 46 of the locking member 45 and the abutment surface 41 of the cylinder 37.

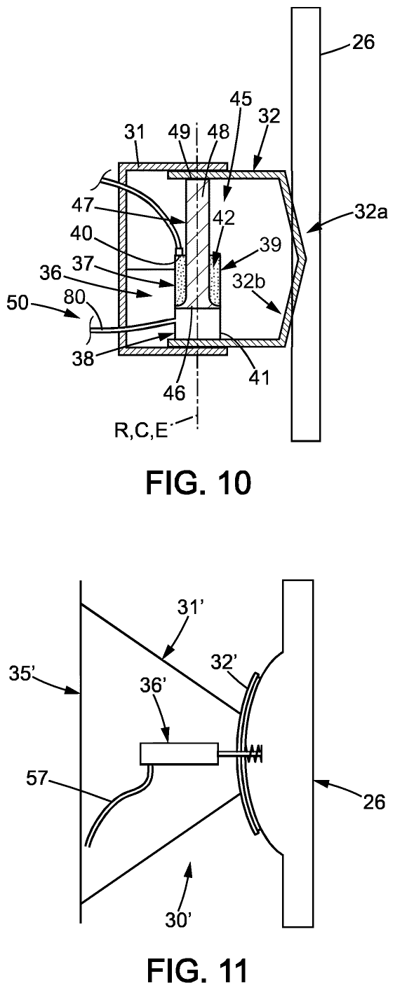

For example, in a fourth variant shown in FIG. 10, the urging arrangement 50 is a pneumatic urging device 80 configured to inject compressed air at a loading pressure between the base 46 of the locking member 45 and the abutment surface 41 of the cylinder 37 in the locked state of the biasing system 35. In the unlocked state of the biasing system 35, either no compressed at all is injected by the air pneumatic urging device 80 or the compressed air at the loading pressure lower than the releasing pressure is injected.

The invention has been disclosed in relation with a movable support part 32 movable in rotation along a single rotation axis R with respect to the fixed support part 31. The invention is however not limited to such embodiment. In particular, the movable support part 32 may by movable in rotation along several rotation axes, possibly combined, with respect to the fixed support part 31. The movable support part 32 may also be movable in translation with respect to the fixed support part 31, the locking device 36 of the biasing system 35 being arranged correspondingly.

In this respect, as can be seen in FIGS. 11 to 13, in a second embodiment, the fixed 31′ and movable 32′ support parts of the support 30′ have respective spherical contact surfaces configured to slide against each other in the unlocked state of the biasing system 35′. Both vertical and horizontal inclination of the movable support part 32′ with respect to the fixed support part 31′ may be adjusted.

In this embodiment, the cylinder 37 of the locking device 36′ is arranged substantially along the longitudinal direction L with the second end wall bearing the abutment surface 41 at proximity of the contact surface of the fixed support part 31′. The locking member 45′ is configured so that the free end 49′ of the contact member 47′ protrudes through the second end wall of the cylinder 37, on a side of the abutment surface 41.

The movable support part 32′ has a trough-hole 34 extending between the back 32b′ and front 32a′ surfaces. The locking device 36′ comprises a friction member 54 interposed between the contact surface of the fixed support part 31′ and the back surface 32b′ of the movable support part 32 bearing the corresponding contact surface.

The rod 48′ of the contact element 47′ of the locking member 45′ extends though the through-hole 34, the free end 49′ of the rod 48′ protruding from the front surface 32a′ of the movable support part 32′.

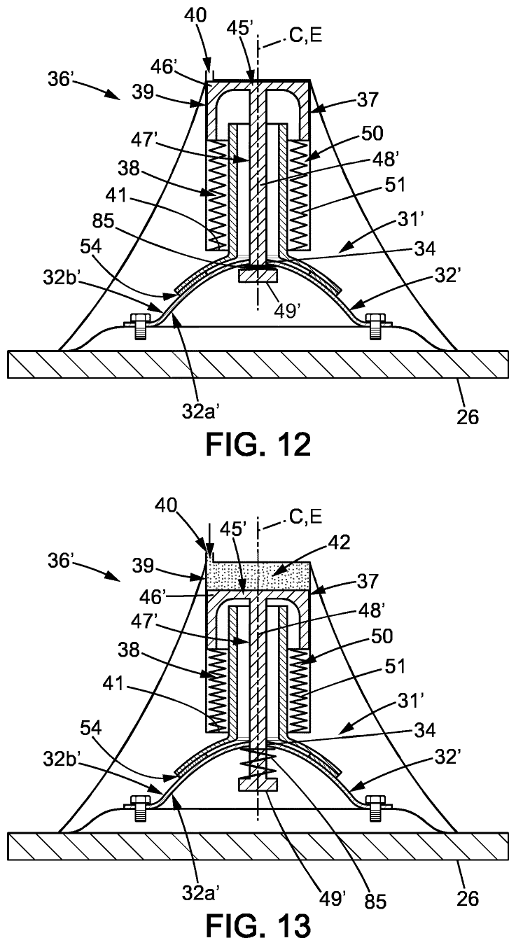

As shown in FIG. 12, in the locked state of the biasing system 35′, the resilient member 51 as urging arrangement 50 is in an extended state urging the locking member 45′ towards the blocking position in which the rod 48′ is retracted within the housing 38 of the cylinder 37. The free end 49′ of the contact element 47′ is configured to be in contact with the front surface 32a′ of the movable support part 32′. In the locked state of the biasing system 35′, the contact surface of the movable support part 32′ is then urged against the friction member 54 of the locking device 36′ thereby preventing the movable support part 32′ to be moved with respect to the fixed support part 31′.

As shown in FIG. 13, in the unlocked state of the biasing system 35′, the resilient member 51 as urging arrangement 50 is in an extended state urging the locking member 45′ towards the releasing position in which the rod 48′ protrudes from the housing 38 of the cylinder 37. The free end 49′ of the contact element 47′ is configured to be spaced apart from the front surface 32a′of the movable support part 32′. In the unlocked state of the biasing system 35′, the movable support part 32′ is released from the load of the resilient member 50 and may be moved in any suitable position with respect to the fixed support part 31′. An elastically deformable element, in the form of a coil spring 85 is interposed between the free end 49′ of the contact element 47′ and the front surface 32a′ of the movable support part 32′ to prevent the monitor from falling when the biasing system 35′ is in the unlocked state.

1. A vehicle comprising:
a frame defining a compartment with a driving place, and
a viewing system configured to provide a driver installed at the driving place with at least one view of surroundings of the vehicle, the viewing system includes:
at least one camera configured to acquire the view of the surroundings,
at least one monitor connected to the camera and configured to display the view of the surroundings, and
at least one support comprising a fixed support part secured to the frame within the compartment, and a movable support part supporting the monitor, the movable support part being movably mounted on the fixed support part to present a plurality of positions with respect to the fixed support part, and
a biasing system presenting a locked state in which the movable support part is maintained in one of the positions with respect to the fixed support part, and an unlocked state in which the movable support part is movable with respect to the fixed support part, the biasing system comprising:
a locking device mounted on the fixed support part and configured to impart a load to the movable support part in the locked state of the biasing system, and
a pneumatic releasing device configured to inject compressed air at a releasing pressure in the locking device so as to release the movable support part from the load in the unlocked state of the biasing system.

2. The vehicle of claim 1, wherein the locking device includes:
a cylinder having a housing extending along a cylinder axis, the cylinder having an injection portion provided with an inlet opening in the housing, and an abutment surface extending transversely with respect to the cylinder axis at a distance from the inlet along the cylinder axis,
a locking member having:
a base mounted in the housing of the cylinder between the inlet and the abutment surface so as to reciprocate along the cylinder axis, the base defining with the injection portion of the cylinder an injection chamber, and
a contact element extending from the base and protruding from the cylinder opposite the injection chamber, and
an urging arrangement,
wherein, in the locked state of the biasing system, the urging arrangement is configured to impart the load between the base of the locking member and the abutment surface of the cylinder, the locking member being in a blocking position in which the base is spaced apart from the abutment surface and the contact element is urged against the movable support part, and
wherein, in the unlocked state of the biasing system, the pneumatic releasing device is configured to inject compressed air in the injection chamber through the inlet against the load of the urging arrangement, the locking member being in a releasing position in which the base is close to the abutment surface and the contact element is spaced apart from the movable support part.

3. The vehicle of claim 2, wherein the urging arrangement is a resilient member placed between the base of the locking member and the abutment surface of the cylinder, the resilient member being in an extended state in the locked state of the biasing system, and in a retracted state in the unlocked state of the biasing system.

4. The vehicle of claim 2, wherein the urging arrangement is a pneumatic urging device configured to inject compressed air at a loading pressure between the base of the locking member and the abutment surface of the cylinder in the locked state of the biasing system.

5. The vehicle of claim 2, wherein the contact element comprises a rod extending from the base along an extension axis parallel to the cylinder axis towards a free end, the free end being in contact with the movable support part in the blocking position of the locking member, and spaced apart from the movable support part in the releasing position of the locking member.

6. The vehicle of claim 5, wherein the contact element comprises a rod extending from the base along an extension axis parallel to the cylinder axis, and a lever rotatably mounted on the rod about a pivot axis perpendicular to the extension axis, the lever having a contact surface at a distance from the pivot axis, the lever presenting a first inclination in the blocking position of the locking member, in which the contact surface is in contact with the movable support part, and a second inclination in the releasing position of the locking member, in which the contact surface is spaced apart from the movable support part.

7. The vehicle of claim 2, wherein the movable support part is movable along a displacement direction and presents a transverse surface perpendicular to the displacement direction, the transverse surface moving along a stroke as the movable support part is moved along the displacement direction, and
wherein the contact element comprises a stop surface arranged to be in contact with the transverse surface of the movable support part in the blocking position of the locking member, and spaced apart from the stroke of the transverse surface of the movable support part in the releasing position of the locking member.

8. The vehicle of claim 1, wherein the pneumatic releasing device comprises a source of compressed air, a pipe connecting the source of compressed air to the locking device and an actuator for controlling supply of compressed air by the source of compressed air, the actuator being arranged within the compartment so as to so as to be actuated by the driver.

9. The vehicle of claim 8, further comprising a steering wheel at the driving place and a height adjusting system for adjusting height of the steering wheel, the source of compressed air and the actuator of the pneumatic releasing device being part of the height adjusting system.

10. The vehicle of claim 1, wherein the movable support part is movable in rotation along at least one rotation axis with respect to the fixed support part.

11. The vehicle of claim 1, wherein the fixed and movable support parts have respective spherical contact surfaces configured to slide against each other in the unlocked state of the biasing system.

12. A method for adjusting position of a monitor of a viewing system configured to provide a driver installed at a driving place of a compartment of a vehicle with at least one view of surroundings of the vehicle, the viewing system comprising at least one camera configured to acquire the view of the surroundings, the monitor being connected to the camera and configured to display the view of the surroundings, the monitor being supported by a movable support part of a support, the movable support part being movably mounted on a fixed support part of the support to present a plurality of positions with respect to the fixed support part, the fixed support part being secured to a frame of the vehicle defining the compartment, and the movable support part being maintained in one of the positions with respect to the fixed support part in a locked state of a biasing system, a locking device of the biasing system being mounted on the fixed support part and imparting a load to the movable support part, the method comprising:
placing the biasing system in an unlocked state in which the movable support part is movable with respect to the fixed support part, a pneumatic releasing device of the biasing system injecting compressed air at a releasing pressure in the locking device so as to release the movable support part from the load.

13. The method of claim 12, wherein the locking device comprises:
a cylinder having a housing extending along a cylinder axis, the cylinder having an injection portion provided with an inlet opening in the housing, and an abutment surface extending transversely with respect to the cylinder axis at a distance from the inlet along the cylinder axis,
a locking member having:
a base mounted in the housing of the cylinder between the inlet and the abutment surface so as to reciprocate along the cylinder axis, the base defining with the injection portion of the cylinder an injection chamber, and
a contact element extending from the base and protruding from the cylinder opposite the injection chamber, and
an urging arrangement,
wherein, in the locked state of the biasing system, the urging arrangement imparting the load between the base of the locking member and the abutment surface of the cylinder, the locking member being in a blocking position in which the base is spaced apart from the abutment surface and the contact element is urged against the movable support part, and
wherein, in the unlocked state of the biasing system, the pneumatic releasing device injects compressed air in the injection chamber through the inlet against the load of the urging arrangement, the locking member being in a releasing position in which the base is close to the abutment surface and the contact element is spaced apart from the movable support part.
